(19) United States
(12) Patent Application Publication
(10) Pub. No.: US 2013/0044278 A1
(43) Pub. Date: Feb. 21, 2013

(54) LIQUID CRYSTAL DISPLAY DEVICE

(71) Applicants: Akiyoshi Kanemitsu, Niihama-shi (JP); Tomonori Miyamoto, Ibaraki-shi (JP); Motohiro Yamahara, Nara-shi (JP); Yasuhiro Haba, Niihama-shi (JP)

(72) Inventors: Akiyoshi Kanemitsu, Niihama-shi (JP); Tomonori Miyamoto, Ibaraki-shi (JP); Motohiro Yamahara, Nara-shi (JP); Yasuhiro Haba, Niihama-shi (JP)

(21) Appl. No.: 13/580,846

(22) PCT Filed: Feb. 23, 2011
(86) PCT No.: PCT/JP2011/054047

§ 371 Date: Oct. 9, 2012

(30) Foreign Application Priority Data
Feb. 25, 2010 (JP) 2010 040479

(51) Int. Cl. G02F 1/13357

(52) U.S. Cl. 349/64

(57) ABSTRACT

In a liquid crystal display device, display with a wide viewing angle and high color reproducibility is achieved and superior contrast is obtained. In addition, a viewing angle is enlarged without using a retarder. The liquid crystal display device comprises a liquid crystal cell 1, a backlight device 2, a first light diffusing layer 3, a first polarizer 4, and a second light diffusing layer 5. The first light diffusing layer 3 comprises a light diffusing plate 31 and a prism sheet 32. The first light diffusing layer 3 has light distribution characteristics such that a luminance value in a direction of 70 degrees with respect to a normal of a light incidence plane of the liquid crystal cell is 20% or less with respect to a luminance value in a direction of the normal. The second light diffusing layer 5 comprises a second polarizer 51 and a light diffusing membrane 52. In addition, the backlight device 2 is divided into a plurality of regions and is capable of controlling luminance per region.

### TECHNICAL FIELD

The present invention relates to a liquid crystal display device and, more specifically, to a liquid crystal display device with superior viewing angle characteristics.

### BACKGROUND ART

In recent years, liquid crystal display devices have been used in an increasingly widening range of applications from small-sized mobile electronic devices such as mobile phones and PDAs (Personal Digital Assistants) to large-sized electric appliances such as personal computers and television sets.

With a liquid crystal display device, unlike self-emitting display devices such as a CRT or a PDP (Plasma Display Panel), a display element itself does not emit light. Therefore, in a case of a transmissive liquid crystal display device, a backlight device is provided on a back surface side of liquid crystal display elements, whereby an image is displayed by having the liquid crystal display elements control an intensity of transmitted illumination light from the backlight device per pixel.

Liquid crystal display devices employ various systems including the TN (Twisted Nematic) system, the STN (Super Twisted Nematic) system, the VA (Vertical Alignmen) system, and the IPS (In-plane Switching) system. However, each of these systems have a direction (azimuth) with a narrow viewing angle which is attributable to light leakage caused by liquid crystal molecules having a phase difference value, a deviation in axis angles of a polarizer when perspectively viewed, and the like.

In consideration thereof, as a method of enlarging a viewing angle, a method of using a retarder to provide optical compensation to a liquid crystal cell or a polarizer is widely adopted (for example, refer to Patent Literature 1 and Patent Literature 2).

### CITATION LIST

### Patent Literature

Patent Literature 1: Japanese Patent Application Laid-open Publication No. H4-229828

Patent Literature 2: Japanese Patent Application Laid-open Publication No. H4-258923

### SUMMARY OF INVENTION

### Technical Problem

An object of the present invention is to provide a liquid crystal display device capable of realizing a wide viewing angle and obtaining superior contrast.

In addition, another object of the present invention is to provide a liquid crystal display device capable of enlarging a viewing angle without using a retarder or, in other words, without increasing the number of parts.

### Solution to Problem

A liquid crystal display device according to the present invention comprises: a liquid crystal cell in which a liquid crystal layer is provided between a pair of substrates; a backlight device provided on a back surface side of the liquid crystal cell; a first light diffusing layer arranged between the backlight device and the liquid crystal cell; a first polarizer arranged between the first light diffusing layer and the liquid crystal cell; and a second light diffusing layer arranged on a front surface side of the liquid crystal cell. The first light diffusing layer has both or one of a light diffusing function and a light polarizing function. Emergent light from the first light diffusing layer has light distribution characteristics such that a luminance value in a direction of 70 degrees with respect to a normal of a light incidence plane of the liquid crystal cell is 20% or less with respect to a luminance value in the direction of the normal. The second light diffusing layer is constituted by a second polarizer and a light diffusing membrane provided on a front surface side of the second polarizer. The backlight device is divided into a plurality of regions and is capable of controlling luminance per region. In the present description, a side that becomes a display screen of the liquid crystal display device will be referred to as a “front surface side” and a side opposite thereto will be referred to as a “back surface side”.

In this case, it is favorable that the backlight device comprises LEDs respectively provided in correspondence with the plurality of regions.

It is favorable that the emergent light from the first light diffusing layer includes non-parallel light.

The first light diffusing layer may have both a light diffusing function and a light polarizing function.

In addition, the first light diffusing layer may comprise a light diffusing plate that performs the light diffusing function and a light polarizing structure board that performs the light polarizing function, and the first light diffusing layer may be constituted such that the light polarizing structure board is provided on a front surface side of the light diffusing plate.

It is favorable that the liquid crystal cell is one of a TN liquid crystal cell, an IPS liquid crystal cell, and a VA liquid crystal cell.

In addition, it is favorable from the perspective of further improving viewing angle characteristics and color reproducibility that a retarder is further arranged on a back surface side and/or a front surface side of the liquid crystal cell.

On the other hand, from the perspective of reducing the number of parts to improve assemblability and increase productivity of the device, a retarder may not be provided.

Furthermore, the liquid crystal cell may be a TN liquid crystal cell and a retarder may not be provided.

It is favorable that the light diffusing membrane has light diffusion characteristics such that a relative intensity of a laser beam emergent in a direction that is inclined by 40 degrees with respect to a normal direction of a back surface of the light diffusing membrane at a position of 280 nm from a front surface of the light diffusing membrane relative to an intensity of a laser beam with a wavelength of 543.5 nm that is incident from the normal direction of the back surface of the light diffusing membrane is 0.0002% or greater.

### Advantageous Effects of Invention

With the liquid crystal display device according to the present invention, a wide viewing angle, high display quality, and superior contrast are obtained. In addition, viewing angle characteristics that are sufficient for actual use can be obtained without having to use a retarder.

### BRIEF DESCRIPTION OF DRAWINGS

FIG. 1 is a schematic view showing an example of a liquid crystal display device according to the present invention;

FIG. 2 is a front view showing an example of a backlight device;

FIG. 3 is a front view showing another example of a backlight device;

FIG. 4 is a front view showing yet another example of a backlight device;

FIG. 5 is a schematic view showing an example of a first light diffusing layer;

FIG. 6 is a schematic view showing another example of a first light diffusing layer;

FIG. 7 shows an example of a method of measuring a luminance value regarding the first light diffusing layer in a direction of 70 degrees with respect to a normal of a light incidence plane of a liquid crystal cell;

FIG. 8 is a diagram for explaining a definition of non-parallel light;

FIG. 9 is a schematic view showing a configuration example of a second light diffusing layer;

FIG. 10 is a diagram schematically showing an incident direction and an emergent direction of a laser beam with respect to the second light diffusing layer;

FIG. 11 is an example of a graph that plots a relative intensity of a laser beam emergent from the second light diffusing layer with respect to an emergent angle;

FIG. 12 is a schematic view showing another example of a liquid crystal display device according to the present invention;

FIG. 13 is a diagram for explaining a method of measuring light distribution characteristics of a backlight device according to an example;

FIG. 14 is a graph showing a luminance of each block at a viewing angle of 0 degrees;

FIG. 15 is a graph showing a luminance of each block at a viewing angle of 30 degrees and an azimuth of 45;

FIG. 16 is a graph showing a luminance of each block at a viewing angle of 30 degrees and an azimuth of 135 degrees;

FIG. 17 is a graph showing a luminance of each block at a viewing angle of 70 degrees and an azimuth of 45 degrees; and

FIG. 18 is a graph showing a luminance of each block at a viewing angle of 70 degrees and an azimuth of 135 degrees.

### DESCRIPTION OF EMBODIMENTS

While a liquid crystal display device according to the present invention will be described below with reference to the drawings, it is to be understood that the present invention is by no means limited to the following embodiments.

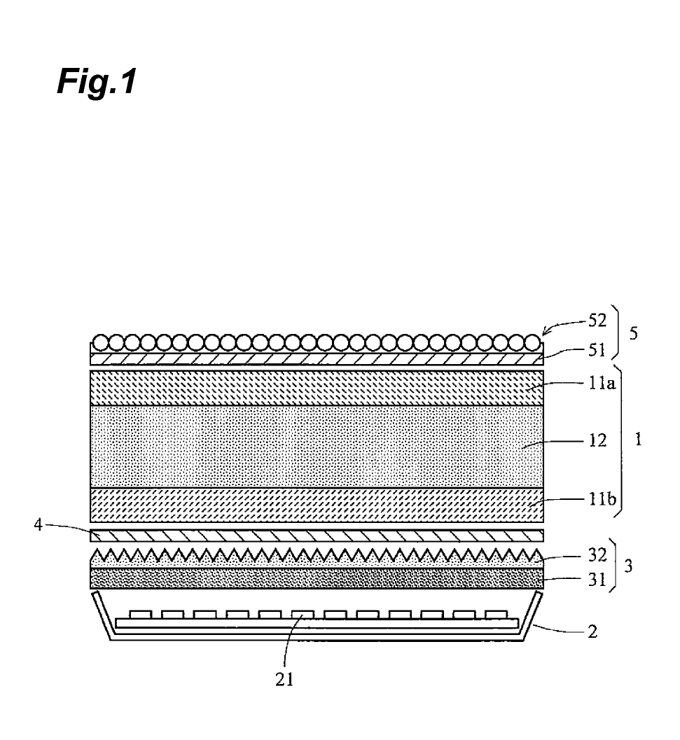

FIG. 1 is a schematic view showing an embodiment of the liquid crystal display device according to the present invention. The liquid crystal display device shown in FIG. 1 is a normally white mode TN liquid crystal display device. The liquid crystal display device shown in FIG. 1 comprises a liquid crystal cell 1 in which a liquid crystal layer 12 is provided between a pair of transparent substrates 11a and 11b, and a direct-lit backlight device 2 which is provided on a back surface side of the liquid crystal cell 1 and in which a plurality of LEDs 21 are installed in a matrix pattern. A first light diffusing layer 3 and a first polarizer 4 are arranged in this order from the side of the backlight device between the backlight device 2 and the liquid crystal cell 1, and a second light diffusing layer 5 is arranged on a front side surface of the liquid crystal cell 1. The first light diffusing layer 3 is constituted by a light diffusing plate 31 which performs a light diffusing function and a prism sheet (light polarizing structure board) 32 which is provided on a front side surface of the light diffusing plate 31 and which performs a light polarizing function. The second light diffusing layer 5 is constituted by a second polarizer 51 and a light diffusing membrane 52 provided on a front side surface of the second polarizer 51.

In the liquid crystal display device configured as described above, light emitted from the backlight device 2 is first diffused by the light diffusing plate 31 of the first light diffusing layer 3 and subsequently given a predetermined directionality with respect to a normal direction of a light incidence plane of the liquid crystal cell 1 by the prism sheet 32. The light having been given a predetermined directionality is changed to a straight polarized light by the first polarizer 4 and is incident to the liquid crystal cell 1. A polarization plane of the light incident to the liquid crystal cell 1 is controlled per pixel by an orientation of the liquid crystal layer 12 that is controlled by an electric field, and the light incident to the liquid crystal cell 1 is emergent from the liquid crystal cell 1. Subsequently, the light emergent from the liquid crystal cell 1 is subjected to imaging and diffusion by the second light diffusing layer 5.

As described above, with the liquid crystal display device according to the present invention, due to the first light diffusing layer 3, the directionality in a normal direction of light incident to the liquid crystal cell 1 is increased compared to what is conventional or, in other words, light incident to the liquid crystal cell 1 is less diffused compared to what is conventional and, at the same time, light emergent from the liquid crystal cell 1 is diffused by the second light diffusing layer 5 to a degree at which a sufficient viewing angle is obtained. Accordingly, wide viewing angle characteristics that are superior compared to what is conventional may be obtained. In addition, with the liquid crystal display device according to the present invention, since the directionality in the normal direction of light incident to the liquid crystal cell 1 has been increased compared to what is conventional by providing the first light diffusing layer 3, light leakage is suppressed. Therefore, higher color reproducibility than that of conventional liquid crystal display devices is obtained. In particular, further superior color reproducibility may be obtained by using a color dimming control technique.

Hereinafter, respective members of the liquid crystal display device according to the present invention will be described. Firstly, the liquid crystal cell 1 used in the present invention comprises a pair of transparent substrates 11a and 11b which are arranged so as to oppose each other across a predetermined distance and which are separated from each other by a spacer (not shown), and an liquid crystal layer 12 constituted by confining liquid crystals between the pair of transparent substrates 11a and 11b. Although not shown in FIG. 1, a transparent electrode and an alignment film are laminatedly formed on each of the pair of transparent substrates 11a and 11b, and liquid crystals are oriented when a voltage based on display data is applied between the transparent electrodes. As a display system of the liquid crystal cell 1, display systems such as the TN system, the TPS system, and the VA system may be adopted.

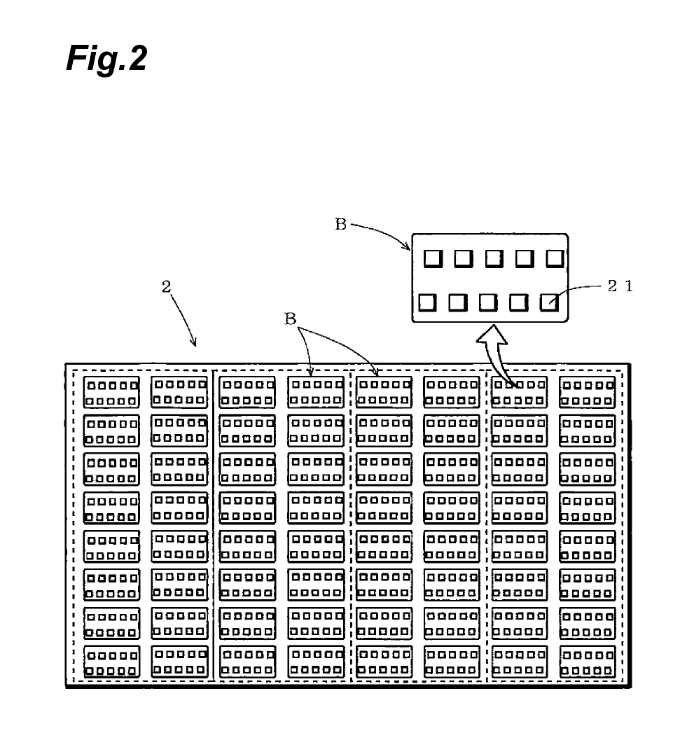

FIG. 2 shows a plan view of the backlight device 2. In the configuration of the backlight device 2 shown in FIG. 2, a plurality of LEDs (Light Emitting Diodes) 21 are arranged in a matrix pattern. In addition, the LEDs 21 are divided into a plurality of blocks B each consisting of a same predetermined number of LEDs. By adjusting a value of a current that conducts the LEDs 21 per block, luminance is controlled per block (local dimming control). The luminance of the LEDs 21 is approximately proportional to the value of the conducting current.

According to such local dimming control, for example, by reducing the luminance of a block that irradiates light to a portion of the liquid crystal cell 1 which has a large number of lower scale pixels and, at the same time, increasing the luminance of a block that irradiates light to a portion which has a large number of higher scale pixels, a local contrast feeling of a video or an image displayed in a display region is enhanced.

An example of the LEDs 21 used in the present invention includes a single white light-emitting LED comprising three LED chips which respectively emit red light, blue light, and blue light. Another example of the LEDs 21 used in the present invention includes an LED which connects and integrates three LEDs which respectively emit red light, blue light, and blue light. Yet another example of the LEDs 21 used in the present invention includes an LED which emits white light by combining a blue light-emitting LED chip or an near-ultraviolet light-emitting LED chip with a phosphor.

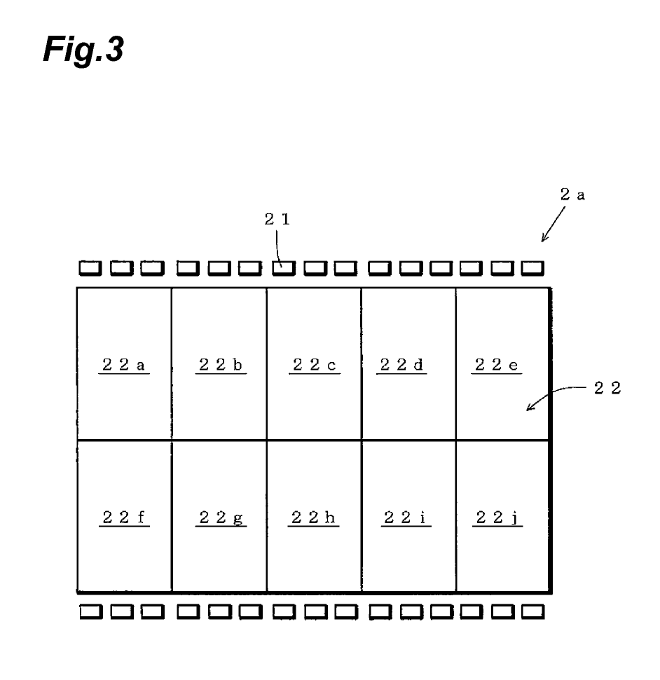

The backlight device 2 used in the present invention is not limited to the direct-lit backlight device shown in FIG. 2. The backlight device 2 used in the present invention may be a so-called side-lighting backlight device in which a light source is arranged on a side surface of a light-guiding plate. FIG. 3 shows an example of a side-lighting backlight device. In the configuration of the side-lighting backlight device 2a shown in FIG. 3, a plurality of LEDs 21 are arranged on both side surfaces of a light-guiding plate 22 which oppose each other. The light-guiding plate 22 is divided into a plurality of blocks 22a to 22j. The LEDs 21 are also divided in correspondence with each of the blocks 22a to 22j of the light-guiding plate 22, and conduction control to the LEDs 21 is enabled for each of the blocks 22a to 22j. Accordingly, local dimming control is performed. In particular, among local dimming control described above, conduction control using an LED that connects and integrates three LEDs which respectively emit red light, blue light, and blue light to individually emit each color in accordance with a color of a video signal is referred to as a color dimming control technique.

The light-guiding plate 22 is formed of a translucent member. Examples of a translucent member include methacrylic resins, acrylic resins, polycarbonate resins, polyester resins, and cyclic polyolefin resins. A plurality of protruding strips (not shown) are arranged in contact with each other and parallel to a light incidence plane on a bottom surface of the light-guiding plate 22. By incrementally adjusting the sizes of the protruding strips, a light quantity distribution of light emergent from an emergence plane is adjusted. Examples of a sectional shape of the protruding strips include a triangle, a wedge-shape, other polygons, a wave-shape, and a semi-ellipsoid. In this case, the protruding strips are favorably arranged so that a formation interval becomes narrower the further away from the light incidence plane. Alternatively, a height of the protruding strips favorably increases the further away from the light incidence plane. In addition, the protruding strips may be formed such that a difference in the shapes of the protruding strips increases the further away from the light incidence plane. Light emergent from a side of the bottom surface of the light-guiding plate 22 may be reflected to an emergence plane side of the light-guiding plate 22 by arranging a reflective sheet (not shown) below the bottom surface of the light-guiding plate 22.

Light from the LEDs 21 is incident to the light-guiding plate 22 from a side surface of each block 22a to 22j of the light-guiding plate 22 which corresponds to each of the LEDs 21, proceeds through the inside of the light-guiding plate while repetitively performing total reflections, and is sequentially emergent from the emergence plane (upper surface) due to the protruding strip structure. Since light is totally reflected by the contact side surface of each block 22a to 22j, light does not leak to another block.

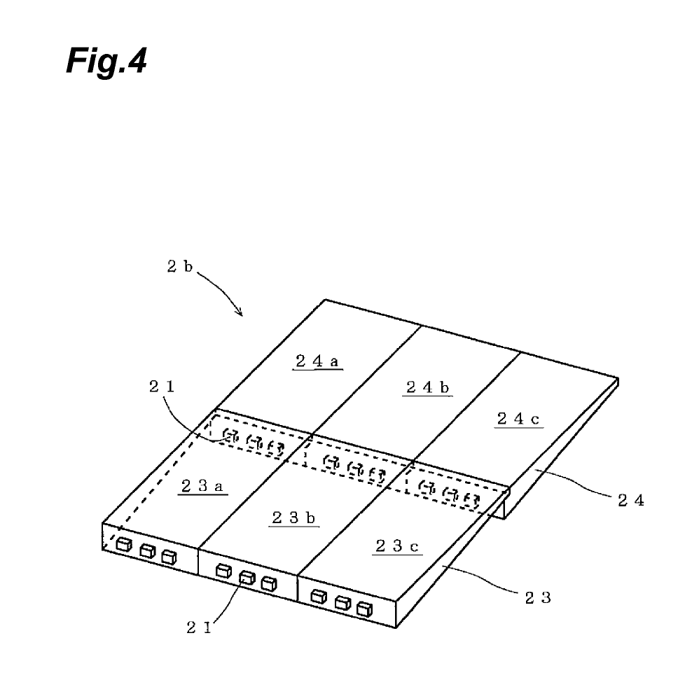

Furthermore, the backlight device used in the present invention may be a so-called tandem backlight device in which combinations of a light-guiding plate and a light source are arranged in series. FIG. 4 shows an example of a tandem backlight device. In the tandem backlight device 2b shown in FIG. 4, combinations of an LED 21 as a light source and wedge-shaped light-guiding plates 23 and 24 which have a light incidence plane opposing the LED 21 and whose thickness decreases the further from the light incidence plane are arranged in series. In a similar manner to the case of the side-lighting backlight device shown in FIG. 3, the light-guiding plates 23 and 24 are divided into a plurality of blocks 23a to 23c and 24a to 24c. The LEDs 21 are also divided in correspondence with each of the blocks 23a to 23c and 24a to 24c, and conduction control to the LEDs 21 is enabled for each of the blocks 23a to 23c and 24a to 24c. Accordingly, local dimming control is performed.

According to such a tandem backlight device 2b, a light emitting area can be increased and a space for arranging the LEDs 21 can be obtained more easily. Examples of the material, configuration, and the like of the light-guiding plates 23 and 24 are similar to the light-guiding plate of the side-lighting backlight device.

While the respective backlight devices described above use LEDs as a light source, light sources are not limited to LEDs. Conventional and known light sources such as a cold cathode fluorescent light can also be used by the respective backlight devices. However, LEDs are desirable from the perspectives of energy conservation, thinning of the device, and the like. A low molecule-based organic light-emitting diode or a polymer-based organic light-emitting diode as an organic EL (Electro-luminescence) may be used as the light source of the respective backlight devices.

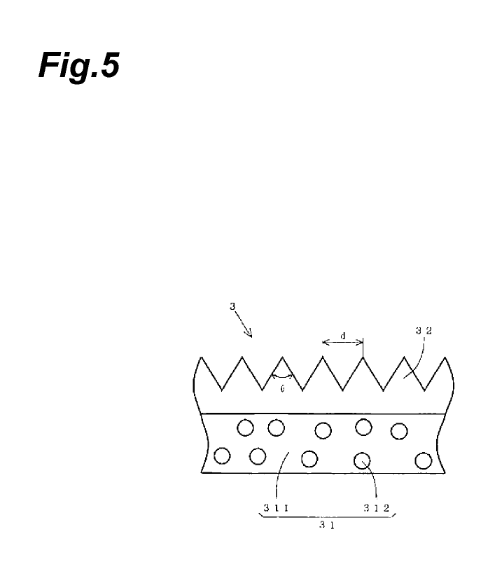

The first light diffusing layer 3 generally comprises a light diffusing plate 31 and a prism sheet 32. Specifically, as shown in FIG. 5, the first light diffusing layer 3 is configured such that the prism sheet 32 is provided on a front surface side of the light diffusing plate 31. As a base material 311 of the light diffusing plate 31, polycarbonate, methacrylic resins, methyl methacrylate-styrene copolymer resins, acrylonitrile-styrene copolymer resins, methacrylate-styrene copolymer resins, polystyrene, polyvinyl chloride, polypropylene, polyolefins such as polymethylpentene, cyclic polyolefin, polyester-based resins such as polyethylene terephthalate, polybutylene terephthalate, and polyethylene naphthalate, polyamide-based resins, polyarylate, polyimide, and the like may be used. In addition, a diffusing agent 312 that is mixed with and dispersed in the base material 311 is microparticles made of a substance with a different refractive index from that of the material of the base material 311. Specific examples of the diffusing agent 312 include organic microparticles such as acrylic resins, melamine resins, polyethylene, polystyrene, organic silicone resins, and acrylic-styrene copolymer and inorganic microparticles such as calcium carbonate, silica, aluminium oxide, barium carbonate, barium sulfate, titanium oxide, and glass of a different type from the material of the base material, whereby one type thereof or a mixture of two or more types thereof are used. Furthermore, a balloon of an organic polymer or glass hollow beads can also be used as the diffusing agent 312. It is preferable that the diffusing agent 312 has a mean particle diameter that ranges from 0.5 μm to 30 μm. In addition, besides a spherical shape, the diffusing agent 312 may have a flat shape, a plate shape, or a needle shape.

Meanwhile, the light incidence plane of the prism sheet 32 is a flat surface, while the light emergence plane of the prism sheet 32 is a prism surface on which V-shaped straight grooves are formed arranged parallel to each other. Examples of a material of the prism sheet 32 include polycarbonate resins, ABS resins, methacrylic resins, methyl methacrylate-styrene copolymer resins, polystyrene resins, acrylonitrile-styrene copolymer resins, and polyolefin resins such as polyethylene and polypropylene. Ordinary thermoplastic resin molding methods may be used as a method of fabricating the prism sheet 32. An example of a thermoplastic resin molding method is heat press molding using a mold. Alternatively, a photopolymer method in which a prism layer is formed on one surface of a transparent base material film using an ultraviolet curable resin and a mold can be used to fabricate the prism sheet 32. A light diffusing agent may be diffused in the prism sheet 32. A thickness of the prism sheet 32 normally ranges from 0.1 to 15 mm and favorably ranges from 0.5 to 10 mm.

The light diffusing plate 31 and the prism sheet 32 may be integrally molded or the light diffusing plate 31 and the prism sheet 32 may be separately fabricated and subsequently integrated. In a case where the light diffusing plate 31 and the prism sheet 32 are separately fabricated and subsequently integrated, the light diffusing plate 31 and the prism sheet 32 may be integrated via another interposed layer such as an air layer or an adhesive layer or may be integrated without an interposed layer.

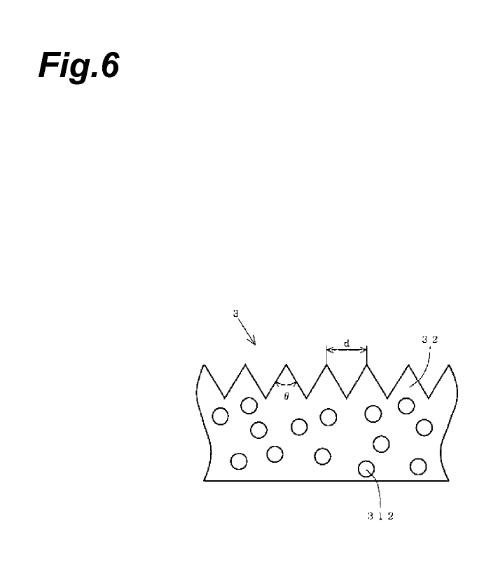

A different embodiment of the first light diffusing layer 3 may be configured such that a diffusing agent 312 is diffused and mixed into a prism sheet 32 that performs a light polarizing function as shown in FIG. 6 so that the prism sheet 32 also performs a light diffusing function.

Regarding the light distribution characteristics of light transmitted through the first light diffusing layer 3, a luminance value in a direction of 70 degrees with respect to the normal of the light incidence plane of the liquid crystal cell 1 is importantly 20% or less with respect to a front luminance value or, in other words, a luminance value in the normal direction of the light incidence plane of the liquid crystal cell 1. More favorable light distribution characteristics are distribution characteristics in which no light exceeds 60 degrees with respect to the normal of the light incidence plane of the liquid crystal cell 1. In addition, the emergent light from the first light diffusing layer includes non-collimated light.

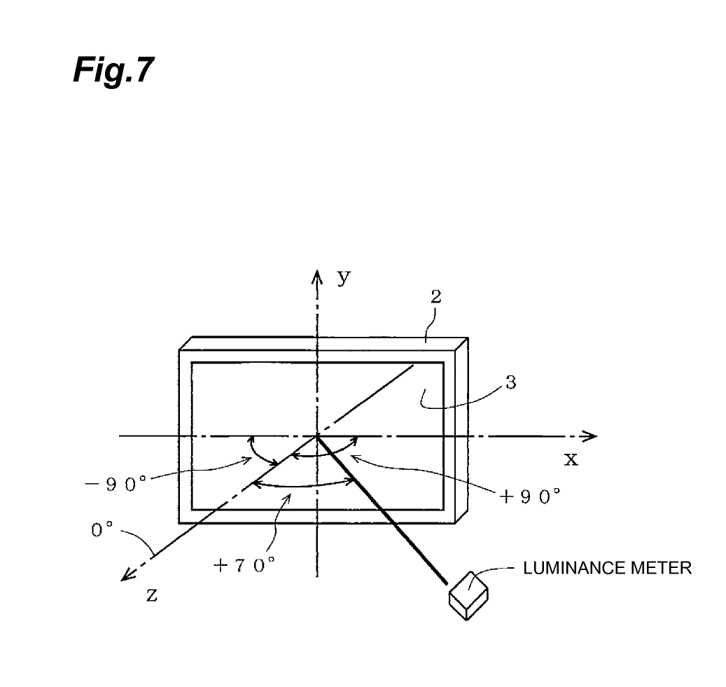

Generally, as shown in FIG. 1, the back surface of the first light diffusing layer 3 and the light incidence plane of the liquid crystal cell 1 are arranged parallel to each other. Therefore, for example, as shown in FIG. 7, if a longitudinal direction of the first light diffusing layer 3 is assumed to be an x direction and a plane parallel to the back surface of the first light diffusing layer 3 is assumed to be an xy plane, then a luminance value in a direction of 70 degrees with respect to the normal of the light incidence plane of the liquid crystal cell 1 is a luminance value in a direction of 70 degrees with respect to a z axis that is a normal with respect to the xy plane and, favorably, a luminance value in a direction which forms an angle of 70 degrees with the z axis on an xz plane.

Such light distribution characteristics can be realized by, for example, adjusting a shape of a prism portion of a cross-sectional triangle of the prism sheet 32. A vertical angle θ (shown in FIG. 5) of the prism portion of the cross-sectional triangle is favorably within a range of 60 to 120 degrees. Whether or not a shape of the triangle that is a cross-sectional shape of the prism portion is equilateral or scalene is arbitrary. However, an isosceles triangle is favorable if converged light in the normal direction of the liquid crystal cell 1, and a structure on a side of the emergence plane of the prism sheet 32 is favorably a structure in which a next isosceles triangle is sequentially arranged adjacent to a base that opposes a vertical angle, each row of vertical angles form a longitudinal axis and the rows are approximately parallel to each other. In this case, unless a significant decline in converging capability occurs, the vertical angles and base angles may have a curvature. A distance d between vertical angles (shown in FIG. 5) is normally within a range of 10 μm to 500 μm and favorably within a range of 30 μm to 200 μm.

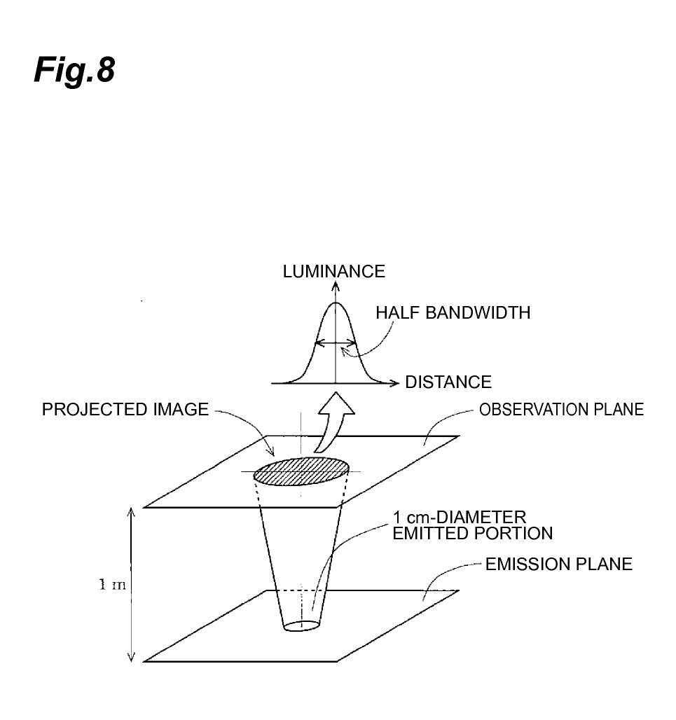

Now, non-collimated light refers to light that has emergence characteristics such that, as shown in FIG. 8, when light emergent from inside of a circle with a diameter of 1 cm (0.01 m) on an incidence plane of the first light diffusing layer 3 is observed as a projected image on an observation plane which is separated by 1 m in a normal direction of the emergence plane and which is parallel to the emergence plane, a minimum half bandwidth of an in-plane luminance distribution of the projected image is 30 cm (0.3 m) or greater.

As the first polarizer 4 used in the present invention, generally, a polarizer with a substrate film bonded to both surfaces is used.

Examples of a polarizer include a polarizer with a dichromatic dye or iodine adsorped and oriented on a polarizer substrate of a polyvinyl alcohol-based resin, a polyvinyl acetate resin, an ethylene/vinyl acetate (EVA) resin, a polyamide resin, or a polyester resin, and a polyvinyl alcohol/polyvinylene copolymer having an oriented molecular chain of a dichromatic dehydration product (polyvinylene) of polyvinyl alcohol contained in a molecularly oriented polyvinyl alcohol film. In particular, a polarizer having a dichromatic dye or iodine adsorped and oriented in a polarizer substrate made of a polyvinyl alcohol-based resin is preferably used.

While a thickness of the polarizer is not particularly limited, generally, for the purpose of thinning of the polarizer or the like, the thickness of the polarizer is favorably 100 μm or less, more favorably within a range of 10 to 50 μm, and even more favorably within a range of 25 to 35 μm.

As a substrate film that supports and protects the polarizer, a film which has low birefringence and which is made of a polymer with superior transparency, mechanical strength, thermal stability, water shielding characteristics, and the like is favorable.

Examples of such a film include resins such as TAC (triacetylcellulose) and other cellulose acetate-based resins, acrylic resins, tetrafluoroethylene/hexafluoropropylene-based copolymers and other fluorine-based resins, polycarbonate resins, polyethylene telephthalate and other polyester-based resins, polyimide-based resins, polysulfone-based resins, polyether sulfone-based resins, polystyrene-based resins, polyvinyl alcohol-based resins, polyvinyl chloride-based resins, polyolefin resins, and polyamide-based resins which have been molded and processed into a film.

Among these examples, a triacetylcellulose film or a norbornene-based thermoplastic resin film subjected to surface saponification by an alkali or the like can be favorably used in terms of polarization characteristics, durability, and the like. A norbornene-based thermoplastic resin film can be used particularly preferable since the film acts as a favorable barrier against heat and moist heat and significantly improves the durability of the polarizer 4 and, due to low moisture absorptivity thereof, significantly improves dimensional stability of the polarizer 4.

Molding and processing into a film can be performed by conventional and known methods such as a casting method, a calender method, and an extrusion method. While a thickness of the substrate film is not particularly limited, generally, for the purpose of thinning of the polarizer 4 or the like, the thickness of the substrate film is favorably 500 μm or less, more favorably within a range of 5 to 300 μm, and even more favorably within a range of 5 to 150 μm.

The second light diffusing layer 5 is generally constituted by the second polarizer 51 and the light diffusing membrane 52 provided on a front side surface of the second polarizer 51. The second polarizer 51 used in this case forms a pair with the first polarizer 4 arranged on a back surface side of the liquid crystal cell 1, and those exemplified for the first polarizer 4 can also be preferably used for the second polarizer 51. However, the second polarizer 51 is arranged so that a polarization plane thereof is perpendicular to a polarization plane of the first polarizer 4. When setting the liquid crystal display device to normally black, the second polarizer 51 is installed so that polarization planes of the first polarizer and the second polarizer are parallel to each other.

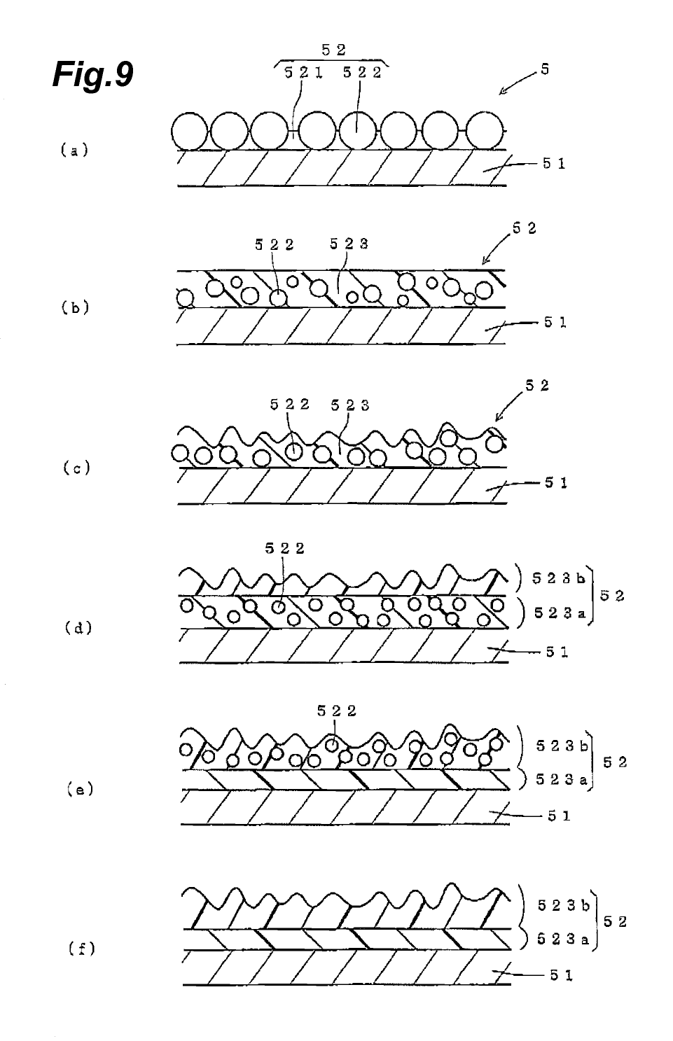

FIG. 9 shows a schematic view of the second light diffusing layer 5. The second light diffusing layer 5 shown in FIG. 9(a) is arranged in the liquid crystal display device shown in FIG. 1. For the second light diffusing layer 5, generally, the second polarizer 51 is coated with a resin solution 521 in which minute fillers 522 have been diffused, and a thickness of the coated film is adjusted so that fillers 522 appear on a surface of the coated film to form minute irregularities on a base material surface.

A surface of the light diffusing membrane 52 generally has minute irregularities. However, minute irregularities need not be present. When there are minute irregularities on the surface of the light diffusing membrane 52, the fillers 522 need not be used. In other words, the light diffusing membrane 52 may achieve light diffusion solely by internal diffusion (internal haze), may achieve light diffusion by both internal diffusion (internal haze) and surface diffusion (external haze and irregularities), or may achieve light diffusion solely by surface diffusion (external haze and irregularities).

FIG. 9(b) shows an example of the second light diffusing layer 5 configured such that the fillers 522 are not exposed on a surface of a base material film 523. In a case where the base material film 523 as the light diffusing membrane 52 is fabricated, the second light diffusing layer 5 is constituted by bonding together the base material film 523 and the second polarizer 51. When bonding the base material film 523 and the second polarizer 51 together, the base material film 523 and the second polarizer 51 favorably come into direct contact with each other instead of via an adhesive layer.

In addition, for example, as shown in FIGS. 9(c), 9(d), and 9(e), the light diffusing membrane 52 may be structured such that the fillers 522 are diffused and mixed in the base material film 523 and minute irregularities are formed on the surface of the base material film 523. In a case of the light diffusing membrane 52 shown in FIG. 9(c), minute irregularities are formed by sandblasting or the like on a surface of the base material film 523 in which the fillers 522 have been diffused and mixed. In a case of the light diffusing membrane 52 shown in FIG. 9(d), a base material film 523b having minute irregularities formed on a surface thereof is bonded to a base material film 523a in which the fillers 522 have been diffused and mixed. In a case of the light diffusing membrane 52 shown in FIG. 9(e), a base material film 523b in which the fillers 522 have been diffused and mixed and which has minute irregularities formed on a surface thereof is bonded to a base material film 523a. As shown in FIG. 9(f), the light diffusing membrane 52 may be structured so that minute irregularities are formed on the surface of the base material film 523 without using fillers. Since a polarizer with a substrate film bonded to both surfaces thereof is generally used as the second polarizer 51, a substrate film of a polarizer may be used as the base material film 523a shown in FIGS. 9(e) and 9(f).

The light diffusing membrane 52 configured as described above has light diffusion characteristics such that a ratio L2/L1 (relative intensity) of an intensity L2 of a laser beam emergent in a direction that is inclined by 40 degrees with respect to a normal direction of a back surface of the light diffusing membrane 52 at a position of 280 nm from a front surface of the light diffusing membrane 52 relative to an intensity L1 of a laser beam with a wavelength of 543.5 nm that is incident from the normal direction of the back surface of the light diffusing membrane 52 is 0.0002% or greater (favorably, 0.001% or less).

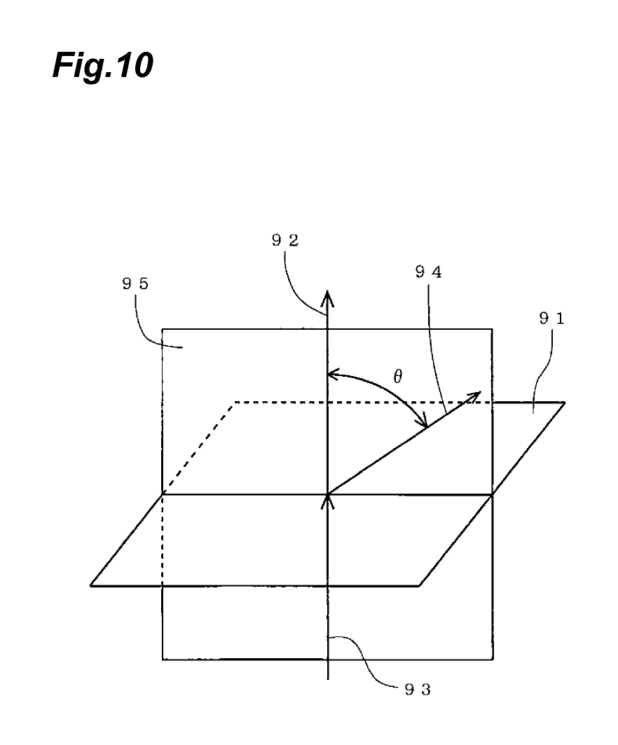

In other words, with reference to FIG. 10, the light diffusing membrane 52 has light diffusion characteristics such that a relative intensity L2/L1 obtained in a case where a laser beam (a parallel light of a He—Ne laser) with a wavelength of 543.5 nm and an intensity of L1 is incident in a direction of a normal 93 of the light diffusing membrane 52 from the back surface of the light diffusing membrane 52 of the second light diffusing layer by measuring an intensity L2 of a laser beam emergent in a direction that is inclined by θ (emergence angle)=40 degrees with respect to the direction of a normal 92 on the side of the light diffusing membrane 52 at a position of 280 nm from a front surface of the light diffusing membrane 52 is 0.0002% or greater (favorably, 0.001% or less). The direction that is inclined by 40 degrees with respect to the direction of the normal 92 on the side of the light diffusing membrane 52 which is the direction of measurement of the intensity of the emergent laser beam is one direction among a plane that includes directions of normals (the normals 92 and 93) of the light diffusing membrane 52.

Accordingly, light transmitted to the front surface side from the liquid crystal cell 1 is forward-scattered, coloring of an image produced by transmitted light as seen from an oblique direction is suppressed while visibility of the image in a front direction is maintained at a high level, and a wider viewing angle is achieved.

In order to control the light diffusion characteristics of the light diffusing membrane 52 as described above, for example, in a case where the fillers 522 are dispersed and mixed, a shape, a particle size, and an additive amount of the fillers 522, a refractive index difference between the fillers 522 and the base material film 523 of the light diffusing film, and the like may be changed. In a case where the fillers 522 are not used, the material, shapes of surface irregularities, and the like of the light diffusing membrane 52 may be changed. Generally, the light emergence plane of the liquid crystal cell 1 and the back surface of the light diffusing membrane are arranged parallel to each other.

Examples of the base material film 523 of the light diffusing membrane 52 include TAC (triacetylcellulose) and other cellulose acetate-based resins, acrylic resins, polycarbonate resins, and polyethylene telephthalate and other polyester-based resins.

Examples of the fillers 522 include microparticles made of a material with a different refractive index from that of the base material film 523 including organic microparticles such as acrylic resins, melamine resins, polyethylene, polystyrene, organic silicone resins, and acrylic-styrene copolymer and inorganic microparticles such as calcium carbonate, silica, aluminium oxide, barium carbonate, barium sulfate, titanium oxide, and glass, whereby one type thereof or a mixture of two or more types thereof are used.

In addition, a balloon of an organic polymer or glass hollow beads can also be used. It is preferable that the fillers 522 have a mean particle diameter that ranges from 1 μm to 25 μm. Although the shape of the fillers 522 may be any of a spherical shape, a flat shape, a plate shape, a needle shape, and the like, a spherical shape is particularly desirable.

Hereinafter, a method of measuring a relative intensity of a laser beam (wavelength 543.5 nm) that is emergent from the light diffusing membrane 52 when a laser beam is incident from a normal direction of the back surface of the light diffusing membrane 52 will be described. A “normal direction of the back surface of the light diffusing membrane 52” refers to a normal direction with respect to a flat back surface of the light diffusing membrane 52, and when the light diffusing membrane 52 comprises the base material film 523, 523a, or 523b as shown in FIGS. 9(b) to 9(f), refers to a direction coinciding with a normal of the base material film 523.

FIG. 10 is a perspective view schematically showing an incident direction and an emergent direction of a laser beam when a laser beam is incident from a normal direction of the back surface of the light diffusing membrane 52 and a relative intensity of a laser beam emergent from the light diffusing membrane is measured. In FIG. 10, with respect to a laser beam 93 incident in a normal direction 92 from a back surface side of a light diffusing membrane 91 (a lower side of the light diffusing membrane 91), an intensity of a laser beam 94 emergent in a direction having an angle θ relative to the normal direction 92 is measured. A relative intensity is obtained by dividing an intensity measured for each angle by an intensity of an incident laser beam. An emergent light 94, the normal direction 92, and a light 93 incident from the back surface side of the light diffusing membrane 52 are measured so that all exist on a same plane (a plane 95 shown in FIG. 10).

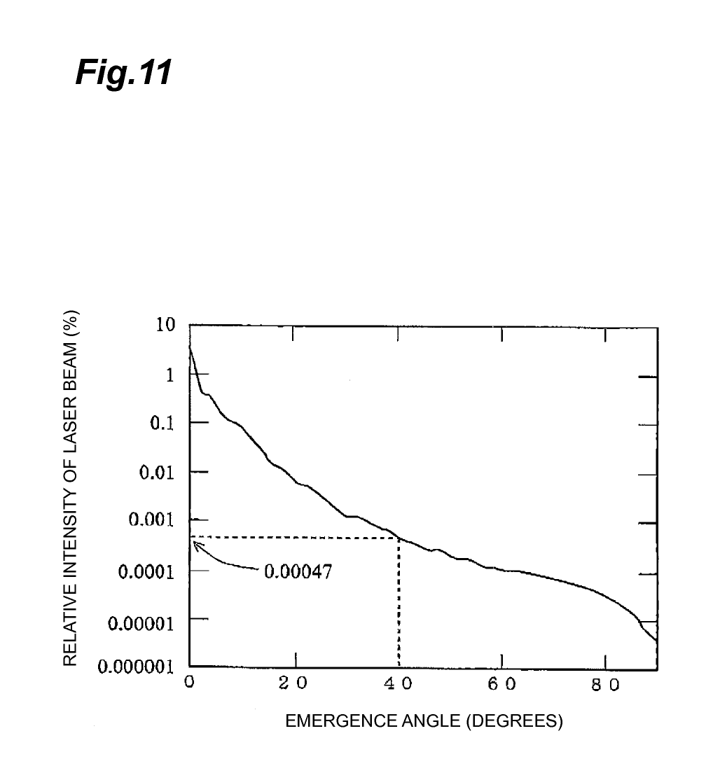

Next, by plotting a relative intensity that is measured as described above with respect to an angle, a relative intensity of a laser beam emergent in a direction that is inclined at 40 degrees with respect to the normal direction of the back surface of the light diffusing membrane 52 is obtained. FIG. 11 is an example of a graph that plots a relative intensity of a laser beam emergent from the light diffusing membrane 52 with respect to a light emergence angle. As shown in the graph, the relative intensity peaks at an light emergence angle of θ degrees or, in other words, the normal direction 92 of the back surface of the light diffusing membrane 52, and has a tendency such that the greater a deviation of an angle from the normal direction 92, the lower the relative intensity. The example shown in FIG. 11 reveals that a relative intensity of a laser beam emergent in a direction that is inclined by 40 degrees with respect to the normal direction of the back surface of the light diffusing membrane 52 is 0.00047%.

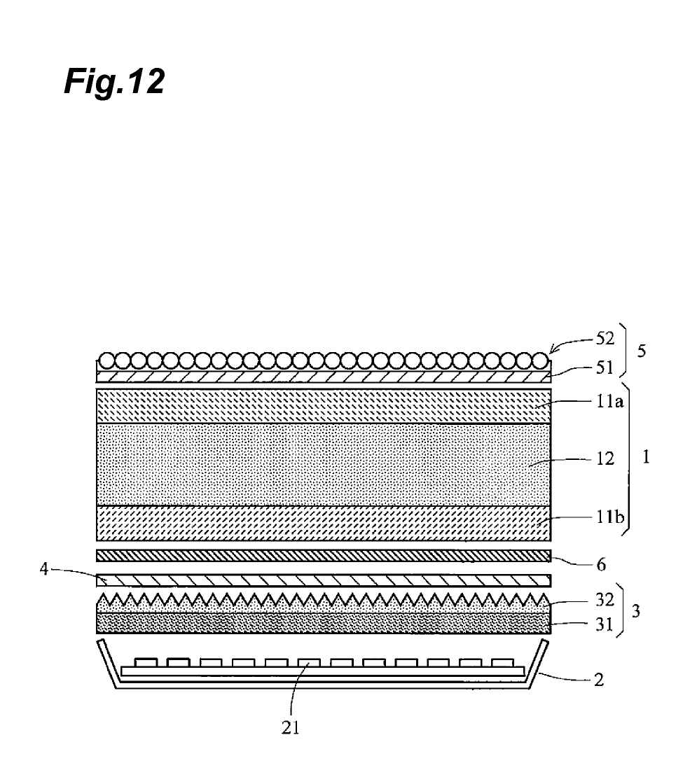

FIG. 12 shows another embodiment of the liquid crystal display device according to the present invention. The liquid crystal display device shown in FIG. 12 differs from the liquid crystal display device shown in FIG. 1 in that a retarder 6 is arranged between the first polarizer 4 and the liquid crystal cell 1. The retarder 6 has a phase difference of approximately zero in a vertical direction with respect to a surface of the liquid crystal cell 1 and has no optical effect at all when viewed from its front side, but a phase difference develops when viewed obliquely to compensate for a phase difference that occurs at the liquid crystal cell 1. Accordingly, a wider viewing angle is obtained and more superior display quality and color reproducibility are achieved. The retarder 6 may be arranged between the first polarizer 4 and the liquid crystal cell 1 and/or between the second light diffusing layer 5 and the liquid crystal cell 1.

Examples of the retarder 6 include a polycarbonate resin or a cyclic olefin-based polymer resin made into a film and further biaxially-stretching the film, and a liquid crystalline monomer having a molecular arrangement thereof fixed by a photopolymerization reaction. The retarder 6 is configured so as to provide optical compensation to a liquid crystal alignment. Therefore, a retarder with refractive index characteristics that are opposite to those of a liquid crystal alignment is used as the retarder 6. Specifically, for example, “WV Film” (manufactured by Fujifilm Corporation) is preferably used as a TN liquid crystal display cell, for example, “LC Film” (manufactured by Nippon Oil Corporation) is preferably used as an STN liquid crystal display cell, for example, a biaxial phase difference film is preferably used as an IPS liquid crystal cell, for example, a retarder that combines an A plate and a C-plate or a biaxial phase difference film is preferably used as a VA liquid crystal cell, and, for example, “WV Film for OCB” (manufactured by Fujifilm Corporation) is preferably used as a π liquid crystal cell.

### EXAMPLES

### Production Example of First Light Diffusing Layer

### (1) Fabrication of Light Diffusing Plate

74.5 parts by mass of a styrene-methyl methacrylate copolymer resin (refractive index 1.57), 25 parts by mass of cross-linked polymethylmethacrylate resin particles (refractive index 1.49, weight average particle diameter 30 μm), 0.5 parts by mass of a benzotriazole-based ultraviolet absorber (“SUMISORB 200” manufactured by Sumitomo Chemicals Co., Ltd.), and 0.2 parts by mass of a hindered phenolic antioxidant (a thermal stabilizer) (“IRGANOX 1010” manufactured by Ciba Specialty Chemicals Co., Ltd.) were mixed by a Henschel mixer and then melted and kneaded by a second extruder, and finally supplied to a feedblock.

Meanwhile, 99.5 parts by mass of a styrene resin (refractive index 1.59), 0.07 parts by mass of a benzotriazole-based ultraviolet absorber (“SUMISORB 200” manufactured by Sumitomo Chemicals Co., Ltd.), and 0.13 parts by mass of a light stabilizer (“TINUVIN 770” manufactured by Ciba Specialty Chemicals Co., Ltd.) were mixed by a Henschel mixer and then melted and kneaded by a first extruder together with cross-linked siloxane-based resin particles (“Trefil DY33-719” manufactured by Dow Corning Toray Co., Ltd., refractive index 1.42, weight average particle diameter 2 μm), and finally supplied to the feedblock. By changing an additive amount of the cross-linked siloxane-based resin particles, a total light transmittance Tt of a diffusing plate was adjusted to fabricate a light diffusing plate with a total light transmittance Tt of 65%.

In the fabrication of the light diffusing layer, by performing co-extrusion molding so that the resin supplied to the feedblock from the first extruder becomes an intermediate layer (base layer) and the resin supplied to the feedblock from the second extruder becomes a surface layer (both surfaces), a light diffusing layer was fabricated as a three-layer laminated plate with a thickness of 2 mm (intermediate layer 1.90 mm, surface layer 0.05 mm×2). In addition, the total light transmittance Tt was measured using a haze trasmissometer (HR-100 manufactured by Murakami Color Research Laboratory) in compliance with JIS K 7361.

(2) Fabrication of Prism Sheet (Light Polarizing Structure Board)

A flat plate with a thickness of 1 mm was fabricated by press-molding a styrene resin (refractive index 1.59). Furthermore, by once again subjecting the styrene resin plate to press molding using a metallic mold on which V-shaped straight grooves having an isosceles triangle cross section with a vertical angle θ (shown in FIG. 5) of 95 degrees and a distance d between vertical angles (shown in FIG. 5) of 50 μm are aligned and formed parallel to each other, a prism sheet was fabricated.

[Production Example of Light Diffusing Membrane for Second Light Diffusing Layer]

### (1) Fabrication of Mirrored Metallic Roll

Industrial chromic plating was performed on a surface of an iron roll (STKM 13A specified by JIS) with a diameter of 200 mm, and the surface was subsequently mirror-polished to fabricate a mirrored metallic roll. A chrome plated surface of the obtained mirrored metallic roll had a Vickers hardness of 1000. The Vickers hardness was measured using an ultrasonic hardness meter MIC 10 (manufactured by Krautkramer Corporation) in compliance with JIS Z 2244 (the same applies to methods of measuring Vickers hardness in the following examples).

(2) Fabrication of Light Diffusing Film

60 parts by mass of pentaerythritol triacrylate and 40 parts by mass of polyfunctional urethanized acrylate (a reaction product of hexamethylene diisocyanate and pentaerythritol triacrylate) was mixed in a propylene glycol monomethyl ether solution, whereby a solid content concentration thereof was adjusted to 60% by weight to obtain an ultraviolet curable resin product. A hardened material produced by removing propylene glycol monomethyl ether from the product and then ultraviolet-curing the product had a refractive index of 1.53.

Next, 17.2 parts by mass of polystyrene-based particles with a weight average particle diameter of 3.0 μm and a standard deviation of 0.39 μm as first translucent microparticles, 25.8 parts by mass of polystyrene-based particles with a weight average particle diameter of 7.2 μm and a standard deviation of 0.73 μm as second translucent microparticles, and 5 parts by mass of “Lucirin TPO” (manufactured by BASF Corporation, chemical name: 2,4,6-trimethylbenzoyldiphenylphosphine oxide) that is a photoinitiator were added to 100 parts by mass of a solid content of the ultraviolet curable resin product described above, whereby the mixture was diluted by a propylene glycol monomethyl ether solution so as to have a solid content ratio of 60% by weight to prepare an application liquid.

The application liquid was applied onto a triacetylcellulose (TAC) film (substrate film) with a thickness of 80 μm, and the substrate film coated with the application liquid was dried for 1 minute in a dryer set to 80° C. The dried substrate film was pressed against and brought into close contact with the mirrored surface of the mirrored metallic roll fabricated in (1) described above by a rubber roll by setting the ultraviolet curable resin product layer to a roll side. In this state, the ultraviolet curable resin product layer was cured by irradiating light from a high-pressure mercury vapor lamp with an intensity of 20 mW/cm2 from the side of the substrate film so as to have an h ray converted light intensity of 300 mJ/cm2, and a light diffusing film was obtained which is constituted by a light diffusing layer having a flat surface and a substrate film and which is structured as shown in FIG. 9(b).

(3) Measurement of Light Diffusion Characteristics of Light Diffusing Membrane

Measurement of light diffusion characteristics was performed using a measurement sample fabricated by bonding a glass substrate to a substrate film-side of the light diffusing film obtained in (2) with an optically transparent adhesive. A parallel light (wavelength 543.5 nm) of a He—Ne laser was incident in a normal direction of the light diffusing film from a glass substrate surface side of the measurement sample, an intensity L2 of a laser beam emergent in a direction inclined by 40 degrees with respect to a normal direction on the light diffusing membrane side was measured, and a value obtained by dividing the intensity L2 of the emergent laser beam with a light intensity L1 of the light source (a relative intensity L2/L1) was calculated. “3292 03 Optical power sensor” and “3292 Optical power meter”, both manufactured by Yokogawa Electric Corporation, were used for the measurement.

Upon performing the measurement, the light source irradiating the He—Ne laser was arranged at a position 430 nm from the glass substrate. The power meter that is a receiver was arranged at a position 280 nm from an emergence point of the laser beam, and by moving the power meter so as to have the predetermined angle described earlier, an intensity of an emergent laser beam was measured.

In addition, an intensity of a laser beam irradiated onto the light diffusing film or, in other words, an intensity of a laser beam irradiated from the light source was obtained without installing the glass substrate to which a light diffusing membrane was bonded by measuring an intensity of light directly incident to the power meter from the light source. Measurement of the intensity was performed by arranging the power meter at a position 710 nm (=430 nm+280 nm) from the light source.

FIG. 11 shows a measurement result of light diffusion characteristics of a light diffusing membrane. From the result shown in FIG. 11, it was found that a relative intensity of a laser beam emergent in a direction that is inclined by 40 degrees with respect to the normal direction of the back surface of the light diffusing membrane 52 is 0.0047%.

### Example 1

As a backlight system for a VA mode 46-inch liquid crystal television set 46ZX8000, manufactured by Toshiba Corporation and using a direct-lit white LED backlight as a light source, a backlight system was fabricated by arranging two prism sheets with a vertical angle of 95 degrees and fabricated as described earlier on a front surface of a light diffusing plate fabricated as described earlier so that the prism sheets were respectively parallel to a shorter side and a longer side of the backlight and respective grooves of the prism sheets formed a right angle with each other, and light distribution characteristics described below were measured per block.

(Light Distribution Characteristics)

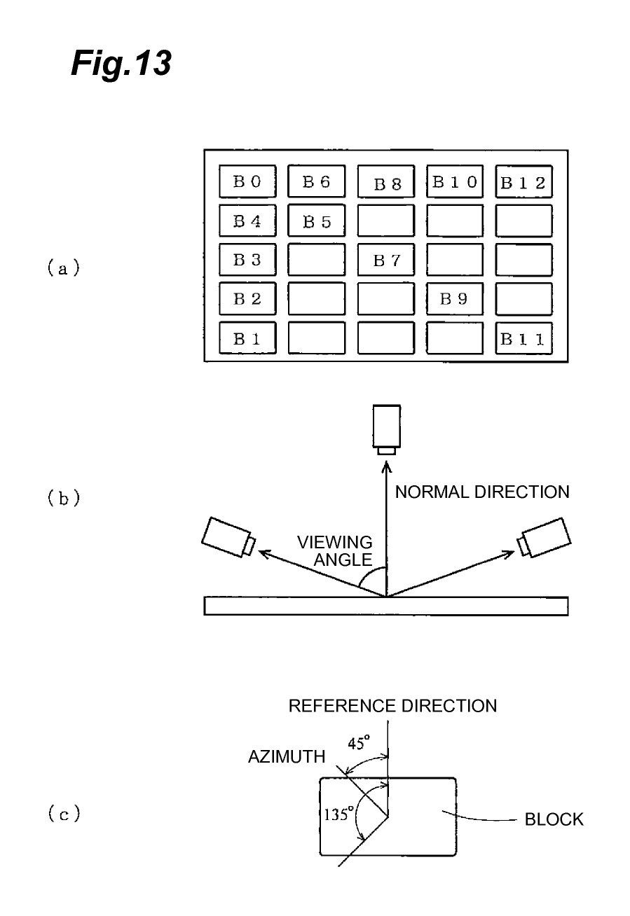

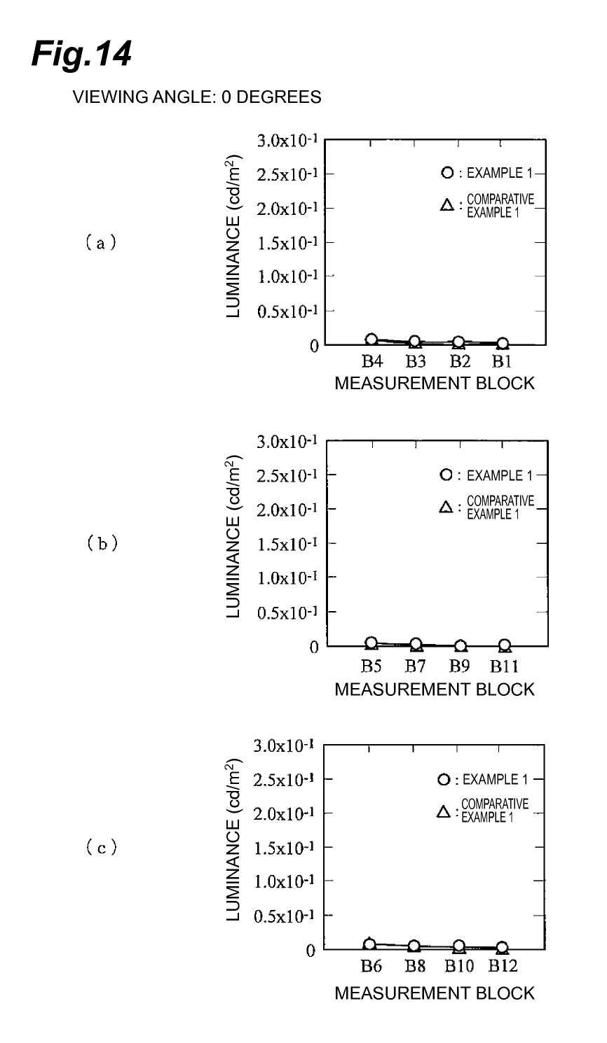

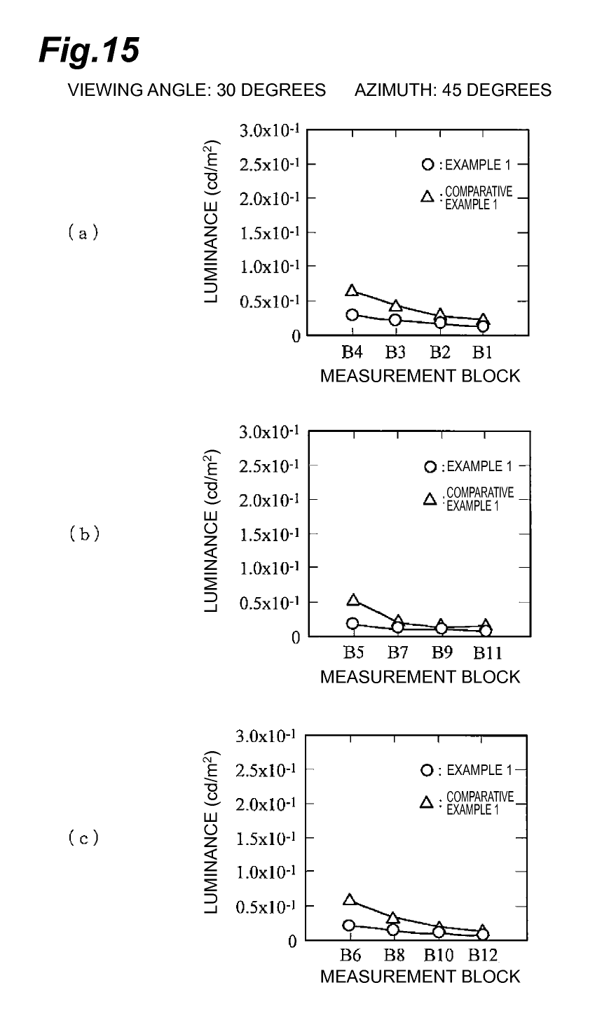

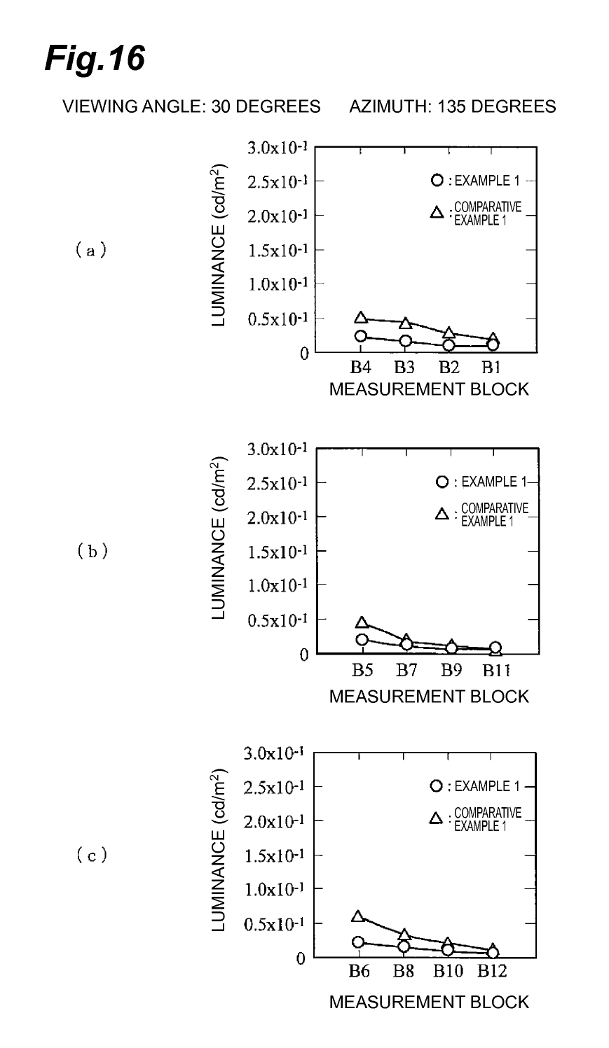

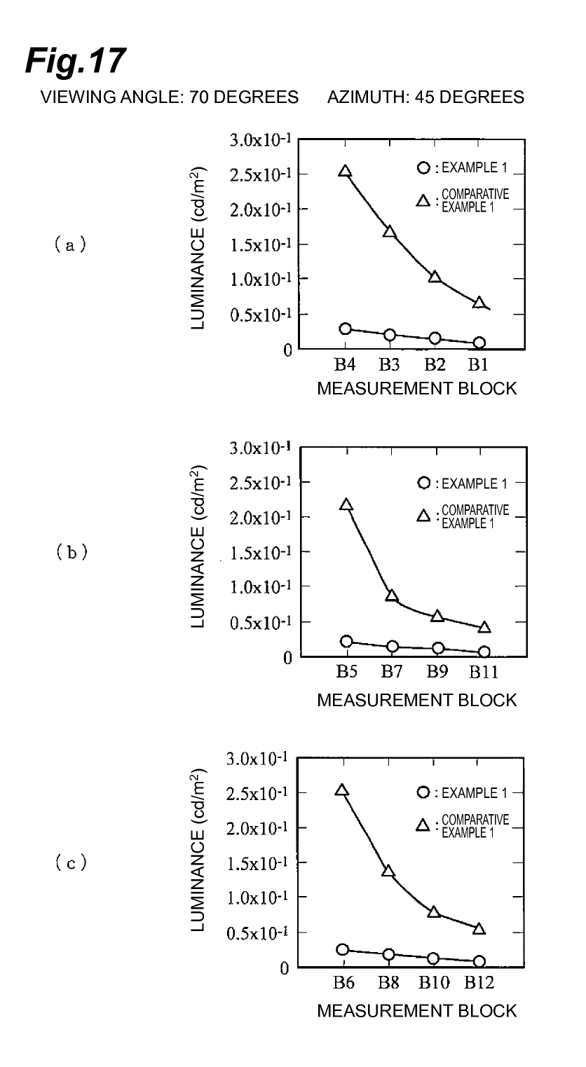

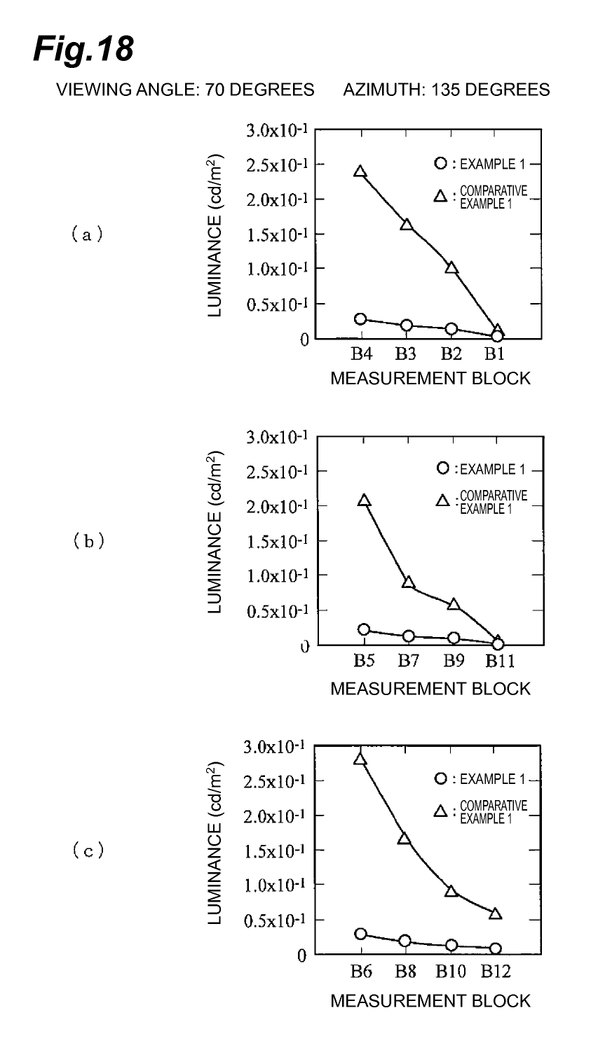

As shown in FIG. 13(a), on the assumption that numbers are assigned to the blocks, only a central block B0 was set to display white while remaining blocks B1 to B12 were all set to display black. Subsequently, for each of the blocks B1 to B12, a luminance was respectively measured for azimuths of 45 degrees and 135 degrees shown in FIG. 13(c) with directly above a center of the block as a reference direction in cases where viewing angles with respect to the normal direction shown in FIG. 13(b) were 0 degrees, 30 degrees, and 70 degrees. Luminance measurement was performed using “BM-5” manufactured by Topcon Corporation. FIGS. 14 to 18 show measurement results.

### Comparative Example 1

Using a commercially available VA mode 46-inch liquid crystal television set 46ZX8000, manufactured by Toshiba Corporation (constituted from a lamp side by a diffusing plate, two diffusing films, and D-BEF), the same measurement as in Example 1 was performed. FIGS. 14 to 18 also show results thereof.

As is apparent from FIGS. 14 to 18, with the backlight system of both Example 1 and Comparative Example 1, the closer a block is to the white display of block 0, the greater the light leakage, and the greater the viewing angle, the greater the light leakage. However, light leakage in Example 1 was dramatically improved in comparison to Comparative Example 1.

### INDUSTRIAL APPLICABILITY

With the liquid crystal display device according to the present invention, a wide viewing angle, high display quality, and superior contrast are obtained. Furthermore, since a viewing angle can be enlarged without using a retarder, the number of parts can be reduced.

### REFERENCE SIGNS LIST

1 liquid crystal cell

2, 2a, 2b backlight device

3 first light diffusing layer

4 first polarizer

5 second light diffusing layer

6 retarder

21 LED

31 light diffusing plate

32 prism sheet (light polarizing structure board)

51 second polarizer

52 light diffusing membrane

522 filler

1. A liquid crystal display device comprising:
a liquid crystal cell in which a liquid crystal layer is provided between a pair of substrates;
a backlight device provided on a back surface side of the liquid crystal cell;
a first light diffusing layer arranged between the backlight device and the liquid crystal cell;
a first polarizer arranged between the first light diffusing layer and the liquid crystal cell; and
a second light diffusing layer arranged on a front surface side of the liquid crystal cell, wherein
the first light diffusing layer has both or one of a light diffusing function and a light polarizing function, and emergent light from the first light diffusing layer has light distribution characteristics such that a luminance value in a direction of 70 degrees with respect to a normal of a light incidence plane of the liquid crystal cell is 20% or less with respect to a luminance value in the direction of the normal,
the second light diffusing layer is constituted by a second polarizer and a light diffusing membrane provided on a front surface side of the second polarizer, and
the backlight device is divided into a plurality of regions and is capable of controlling luminance per region.

2. The liquid crystal display device according to claim 1, wherein the backlight device comprises LEDs respectively provided in correspondence with the plurality of regions.

3. The liquid crystal display device according to claim 1, wherein the emergent light from the first light diffusing layer includes non-collimated light.

4. The liquid crystal display device according to claim 1, wherein the first light diffusing layer has both a light diffusing function and a light polarizing function.

5. The liquid crystal display device according to claim 4, wherein the first light diffusing layer comprises a light diffusing plate that performs the light diffusing function and a light polarizing structure board that performs the light polarizing function, and the first light diffusing layer is constituted such that the light polarizing structure board is provided on a front surface side of the light diffusing plate.

6. The liquid crystal display device according to claim 1, wherein the liquid crystal cell is one of a TN liquid crystal cell, an IPS liquid crystal cell, and a VA liquid crystal cell.

7. The liquid crystal display device according to claim 1, wherein a retarder is further arranged on a back surface side and/or a front surface side of the liquid crystal cell.

8. The liquid crystal display device according to claim 1 which does not comprise a retarder.

9. The liquid crystal display device according to claim 1, wherein the liquid crystal cell is a TN liquid crystal cell and the liquid crystal display device does not comprise a retarder.

10. The liquid crystal display device according to claim 1, wherein the light diffusing membrane has light diffusion characteristics such that a relative intensity of a laser beam emergent in a direction that is inclined by 40 degrees with respect to a normal direction of a back surface of the light diffusing membrane at a position of 280 nm from a front surface of the light diffusing membrane relative to an intensity of a laser beam with a wavelength of 543.5 nm that is incident from the normal direction of the back surface of the light diffusing membrane is 0.0002% or greater.
